(19) United States
(12) Patent Application Publication
(10) Pub. No.: US 2025/0121842 A1
(43) Pub. Date: Apr. 17, 2025

(54) METHOD AND DEVICE FOR PERFORMING RESPONSE ACTION FOR VOICE COMMAND CONSIDERING PASSENGER PROFILE

(71) Applicants: HYUNDAI MOTOR COMPANY, Seoul (KR); KIA CORPORATION, Seoul (KR)

(72) Inventors: Bo Hyun KIM, Seoul (KR); Young Jae PARK, Seoul (KR); Ji Hoon KIM, Seoul (KR)

(21) Appl. No.: 18/743,322

(22) Filed: Jun. 14, 2024

(30) Foreign Application Priority Data
Oct. 13, 2023 (KR) 10-2023-0136629

(51) Int. Cl. B60W 50/10; B60W 50/00; G10L 17/22

(52) U.S. Cl. CPC B60W 50/10; B60W 50/0098; G10L 17/22; B60W 2540/043; B60W 2540/21

(57) ABSTRACT

A method for executing a response action to a voice command based on a passenger profile includes identifying a passenger in a vehicle, and performing a response action corresponding to a voice command based on a passenger profile of the passenger, where the passenger profile includes at least one of a vehicle control range, a POI search option, or preset information.

### CROSS REFERENCE TO RELATED APPLICATION

The present application is based on and claims the benefit of priority to Korean Patent Application Number 10-2023-0136629, filed on Oct. 13, 2023, in the Korean Intellectual Property Office, the entire disclosure of which is incorporated herein by reference.

### TECHNICAL FIELD

The present disclosure relates to a device configured to execute a response action for a voice command based on passenger profiles.

### BACKGROUND

Along with the recent advances in the artificial intelligence techniques, their application scope is also expanding. In particular, conversation systems that interact with users through natural language, such as chatbots or virtual assistants, are widely used in diverse fields, and the related technologies are also steadily advancing. For a conversation system to conduct a conversation with a user, it is necessary to understand the user's utterance, namely, an input message, from the conversation system's perspective. To achieve the Natural Language Understanding (NLU), the conversation system needs to derive the current context from a conversation between the conversation system and the user and the expected intent of the user from the context; and analyze the input message based on the derived current context and/or intent.

The application scope of speech recognition services is expanding from households to diverse fields, including the automotive sector. For example, a speech recognition assistant service and a telematics service operate in conjunction with each other, and voice commands generated by the user's utterances are passed to the car for the controlling of the car. Through the operation, users may lock/unlock the car's doors or control the temperature inside the car by turning on the air conditioner in advance.

However, conventional speech recognition functions often overlook passengers because the functions primarily focus on delivering response actions to the driver's utterances. When a passenger is present in the vehicle, the driver experiences the inconvenience of having to speak voice commands considering the presence of the passenger.

Therefore, there is a need for research on a speech recognition function capable of providing response actions based on the driver's voice commands, while considering the presence of passengers.

### SUMMARY

According to one aspect of the present disclosure, a method for executing a response action to a voice command by referring to a passenger profile can include: identifying a passenger in a vehicle; and executing a response action corresponding to a voice command uttered by a driver or the passenger in the vehicle based on a passenger profile of the passenger. In some implementations, the passenger profile includes at least one of a vehicle control range, a points of interest (POI) search option, or preset information.

According to another aspect of the present disclosure, a device configured to execute a response action to a voice command based on a passenger profile can include a memory storing a passenger profile including at least one of a vehicle control range, a POI search option, or preset information; and a processor configured to (i) identify a passenger in a vehicle and (ii) execute a response action corresponding to a voice command uttered by a driver or the passenger in the vehicle based on a passenger profile of the passenger.

### BRIEF DESCRIPTION OF THE DRAWINGS

FIG. 1 is a diagram illustrating an example of a passenger-specific scenario.

FIG. 2 is a block diagram illustrating an example of a response device.

FIG. 3 is a diagram illustrating an example of a passenger profile.

FIG. 4 is a block diagram illustrating an example of a speech recognition system.

FIG. 5 is a diagram illustrating an exemplary relationship between a vehicle and a speech recognition system.

FIGS. 6A and 6B are diagrams illustrating an example of a passenger identification process and a response action process.

FIG. 7 is a flow diagram illustrating an example of a method for operating a response device.

### DETAILED DESCRIPTION

The present disclosure is directed to a method and a device for providing passenger-specific services by performing response actions based on voice commands with reference to pre-stored passenger profiles.

Embodiments of the present disclosure are described below in detail using various drawings. It should be noted that when reference numerals are assigned to components in each drawing, the same components have the same reference numerals as much as possible, even if they are displayed on different drawings. Furthermore, in the description of the present disclosure, where it has been determined that a specific description of a related known configuration or function may obscure the gist of the disclosure, a detailed description thereof has been omitted.

In describing the components of the embodiments according to the present disclosure, symbols such as first, second, i), ii), a), and b) may be used. These symbols are only used to distinguish components from other components. The identity or sequence or order of the components is not limited by the symbols. In the specification, when a part “includes” or is “equipped with” an element, this means that the part may further include other elements, not excluding other elements unless explicitly stated to the contrary. Further, when an element in the written description and claims is described as being “for” performing or carry out a stated function, step, set of instructions, or the like, the element may also be considered as being “configured to” do so.

Each component of a device or method can be implemented in hardware or software, or in a combination of hardware and software. In addition, the functions of each component can be implemented in software. A microprocessor or processor may execute functions of the software corresponding to each component.

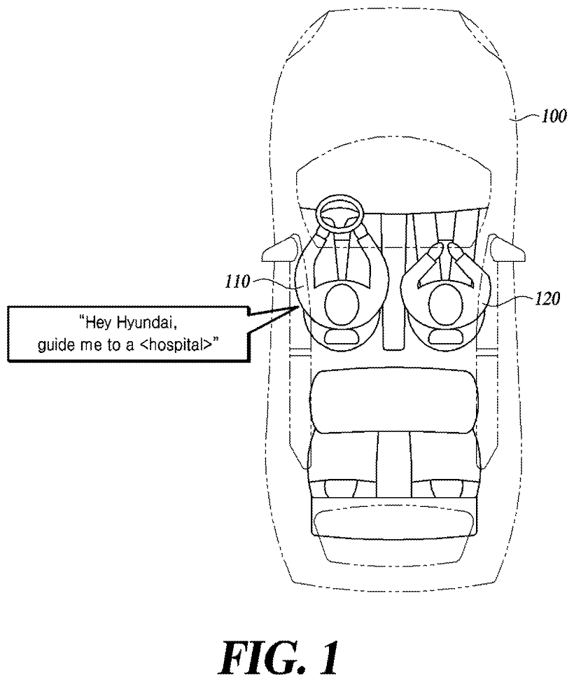

FIG. 1 is a diagram illustrating an example of a passenger-specific scenario.

Referring to FIG. 1, both a driver and a passenger may be present in the vehicle. For example, the driver could be an adult child driving the parent to a hospital.

The driver may utter a sentence “Hey Hyundai, guide me to a <hospital>” to find a route to a specific hospital that the passenger frequently visits. “Hey Hyundai” may be a wake-up word that triggers speech recognition. At this time, it may be assumed that the driver did not utter the name of the specific hospital.

If no additional information is given, the vehicle may not know the name of the specific hospital, such that the vehicle may provide only the information regarding the hospitals around the current location. In this scenario, the driver has to utter the name of the specific hospital or select the specific hospital from a list of nearby hospitals provided to find a route to the hospital.

An exemplary response device can reduce such inconvenience by executing a response action to a voice command based on the passenger profile. The response device can apply the passenger profile to the vehicle, enabling the driver or the passenger to receive information from a simple utterance.

For example, without explicitly uttering the name of a specific hospital, the response device can identify hospitals that the passenger frequently visits based on the Points of Interest (POI) data within the passenger profile.

In another example, when a child or a pet is in the vehicle, the response device can provide a service specialized for the child or pet using the profile of the child or pet.

Thus, the response device can provide a passenger-specific service by pre-storing a profile for each passenger and executing a response action to a voice command based on the profile of the passenger.

The response device can be implemented by at least one of a speech recognition system or a vehicle.

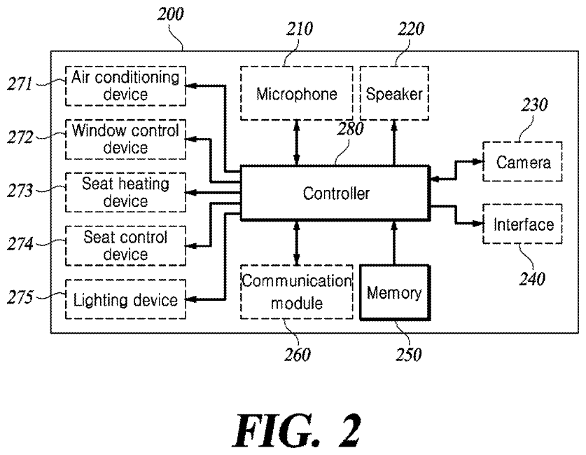

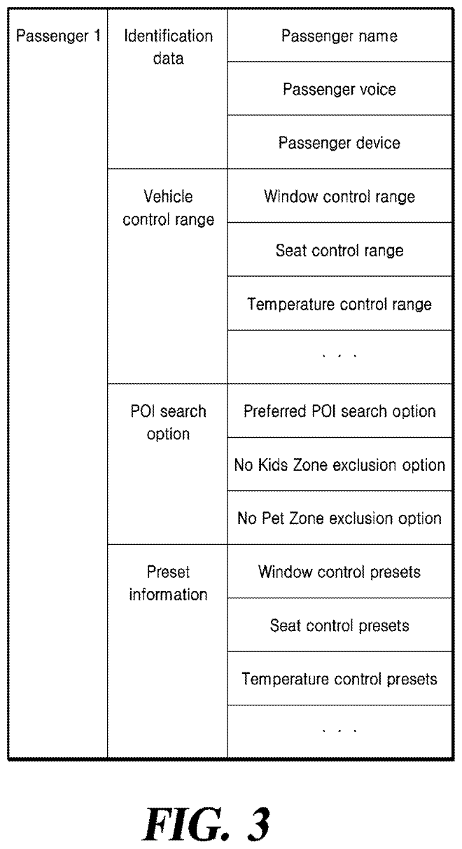

FIG. 2 is a block diagram illustrating an example of a response device. FIG. 3 is a diagram illustrating an example of a passenger profile.

Referring to FIG. 2, the response device 200 can include a memory 250 storing information for providing a service requested by the user and a processor 280 configured to control operations of the vehicle.

When the response device 200 is implemented inside the vehicle, the response device 200 can further include a microphone 210 configured to receive a user's voice, a speaker 220 configured to output a sound for providing a service requested by the user, a camera 230 configured to obtain images around the vehicle, an interface 240 configured to input or output for providing a service requested by the user, a communication module 260 configured to communicate with an external device, and vehicle control components 271, 272, 273, 274, 275.

The microphone 210 can be provided at a location inside the response device 200, where the user's voice may be received. The user who inputs voice into the microphone 210 provided in the response device 200 may be a driver. The microphone 210 can be installed at a location such as a steering wheel, a center fascia, a headlining, or a room mirror to receive the driver's voice or utterance.

In some implementations, two or more microphones 210 can be provided to receive utterances from passengers in the rear seat. The microphone 210 for receiving utterances from rear-seat passengers can be provided in the armrest of the front or rear seat or can be provided in the rear seat door, B pillar, or C pillar.

In addition to the user's voice, various audio sounds generated around the microphone 210 can be input to the microphone 210. The microphone 210 can output an audio signal corresponding to the input audio signal; the output audio signal can be processed by the processor 280 or transmitted to an external server device through the communication module 260.

In addition to the microphone 210, the response device 200 can include an interface 240 configured to receive user commands through a manual input, such as touch. The interface 240 can include an input device in the form of a button or a jog shuttle in the AVN area of the center fascia, the gearbox area, or on the steering wheel.

In some implementations, the interface 240 can include an input device provided on the door of each seat or an input device provided on the armrest of the front or rear seat and receive control commands related to the passenger seat.

In some implementations, the interface 240 can include a touchpad that implements a touch screen built on an input device integrated with a display.

The camera 230 can obtain at least one of an internal image or an external image of the response device 200. Accordingly, the camera 230 can be provided inside the response device 200, outside the response device 200, or both inside and outside the response device 200.

The interface 240 can include an AVN display provided on the center fascia of the response device 200, a cluster display, or a head up display (HUD). In addition or alternatively, the interface 240 can include a rear seat display provided on the back of the headrest of the front seat, allowing passengers in the rear seat to see the interface; in the case of a multi-seat vehicle, the response device 200 can include a display mounted on the headlining.

The display can be positioned anywhere provided it is visible to the user of the response device 200, without any limitations on the number or locations of the displays.

The memory 250 can store a program that controls the processor 280 to perform a method. For example, a program may include a plurality of instructions executable by the processor 280, and the method can be performed as the processor 280 executes the plurality of instructions.

The communication module 260 can exchange signals with other devices by employing at least one of various wireless communication methods such as Bluetooth, 4G communication, 5G communication, or Wi-Fi. In addition or alternatively, the communication module 260 can exchange information with other devices through a cable connected to a Universal Serial Bus (USB) port, auxiliary (AUX) port, and the like. In some implementations, the communication module 260 can include at least one of a transceiver or an antenna.

In some implementations, the communication module 260 can be equipped with two or more communication interfaces that support different communication methods, enabling exchange of information and signals with two or more other devices.

For example, the communication module 260 can communicate with a mobile device located inside the response device 200 through Bluetooth communication to receive information acquired by the mobile device or stored in the mobile device (such as user images, user voices, contact information, schedules, and so on) and can communicate with a server through 4G or 5G communication to transmit the user's voice and receive signals for providing a requested service to the user. In some implementations, the communication module 260 can exchange signals with the server through a mobile device connected to the response device 200.

In some implementations, the response device 200 can include a navigation device configured to provide route guidance, an air conditioning device 271 configured to control the internal temperature, a window control device 272 configured to open or close the window, and a seat heating device 273 configured to heat the seats, a seat control device 274 configured to adjust the position, height, or angle of the seats, and a lighting device 275 that adjusts interior illumination.

The devices described above can provide functions related to the response device 200, and some of the devices may be omitted depending on the vehicle model and options. Also, other devices may be included in addition to the devices described above. Since the driving-related configuration of the response device 200 is well-known, descriptions thereof will be omitted in the present disclosure.

The processor 280 can turn on/off the microphone 210, process or store a voice signal input to the microphone 210, or transmit the input voice to another device through the communication module 260.

In some implementations, the processor 280 can control the display to display images and control the speaker 220 to produce audio output.

In some implementations, the processor 280 can perform various controls related to the response device 200. For example, based on the user's command input through the microphone 210 or interface 240, the processor 280 can control at least one of the navigation device, air conditioning device 271, window control device 272, seat heating device 273, seat control device 274, or lighting device 275.

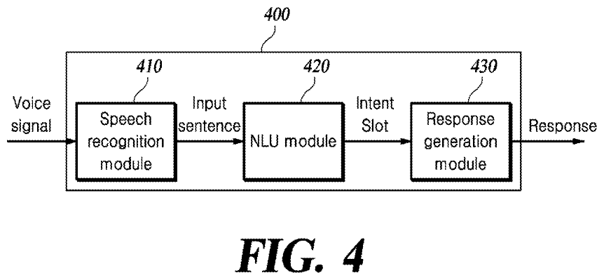

In some implementations, the processor 280 can execute at least part of the functions of the speech recognition system to analyze the utterances of the driver or the passenger. The speech recognition system will be described in detail with reference to FIG. 4.

The processor 280 can include at least one memory storing a program for performing the operation above and the operation to be described later and at least one processor executing the stored program.

In some implementations, the processor 280 can execute a process for registering passenger profiles, a passenger identification process, and a response action process to provide passenger-specific services.

In the process for registering passenger profiles, each passenger's profile can be stored in the memory 250. The passenger profile can record settings tailored to a specific passenger.

Referring to FIG. 3, passenger 1's profile includes at least one of identification data, a vehicle control range, POI search options, or preset information.

The identification data can be used by the response device 200 to identify the passenger 1 within the vehicle.

The identification data can include at least one of the name, voice characteristics, or device information of the passenger 1. Various identification data may be used to identify the passenger 1.

The vehicle control range may refer to the control ranges for the vehicle tailored to passenger 1.

The vehicle control range can include control ranges for various components of the vehicle. The vehicle can be controlled within the vehicle control range. The vehicle control range can include at least one of a window control range, a seat control range, a temperature control range, an air conditioning control range, a lighting control range, a volume control range, or a media control range. For example, the window control range may limit the window to be one-half or one-third open. By way of further example, the media control range may limit the content to adult-only content or kids-only content.

The POI search option may refer to the information for providing the POI customized to passenger 1 in response to the voice command related to a POI search.

The POI search option can include a preferred POI search option, a No Kids Zone exclusion option, or a No Pet Zone exclusion option. POI search options may include various search options.

In some implementations, the preferred POI search option is an option to search for a POI frequently visited by passenger 1 among POIs related to a keyword in a voice command or to search for a preset POI according to the corresponding keyword.

The No Kids Zone exclusion option can be an option used for excluding No Kids Zone POIs among those POIs related to a particular keyword within a voice command.

The No Pet Zone exclusion option can be an option used for excluding No Pet Zone POIs among those POIs related to a particular keyword within a voice command.

The preset information may refer to the presets for the vehicle tailored to passenger 1.

The preset information can include presets for various constituting elements of the vehicles. The preset information can include at least one of the window control presets, seat control presets, temperature control presets, air conditioning control presets, lighting control presets, volume control presets, or media presets. When passenger 1 is identified or when the profile of passenger 1 is applied to the vehicle, the vehicle's windows, seat posture, temperature, air conditioning, lighting, media, and the like can be controlled based on the preset information. For example, media presets can control a specific channel or a specific content application to run.

In some implementations, the profile of passenger 1 can include the profile of passenger 1 in FIG. 3 as part of the entire profile or may exclude a specific portion of the profile of passenger 1 in FIG. 3.

Passenger profiles can be registered in various ways. The driver or the passenger can register the passenger profile through the interface 240 of the response device 200. Alternatively, the passenger profile can be registered to the passenger's own device and then transmitted to the response device 200. In some implementations, when the response device 200 is implemented in a server, the passenger profile may be registered in the vehicle and then transmitted to the response device 200 within the server.

The passenger profiles can be created by either the driver or the passenger. The passenger profile can be created before or during the driving of the vehicle.

Referring to FIG. 2, in the passenger identification process, the processor 280 can identify the passenger in the vehicle using at least one of the initial utterance received from the microphone 210 or the connection status of the passenger device. For example, the initial utterance may refer to the utterance from the driver or the passenger.

In some implementations, the processor 280 identifies a passenger in the vehicle by comparing the names in the initial utterances with the names in the passenger profiles. For example, the processor 280 uses a speech recognition system to convert the initial utterance into text, classify the intent of the initial utterance from the text, and extract slots related to the intent from the text. When the intent is to “provide passenger information,” the processor 280 may recognize the extracted slot as the passenger's name. By way of further example, the processor 280 may recognize the initial utterance, namely, the name within the converted text, as the name of the passenger using predetermined grammar. The processor 280 can identify the passenger by comparing the recognized name with names in the passenger profiles.

In some implementations, the processor 280 identifies a passenger in the vehicle by comparing voice characteristics of the initial utterance with the voice characteristics in the passenger profiles. Specifically, the processor 280 can extract speech features of the passenger's initial utterance using an extraction model. The speech features may be in the vector form. The processor 280 can identify the passenger by comparing the extracted speech features with the speech features in the passenger profiles. For example, the speech features may be represented by an embedding vector or spectrogram, which conveys the audio signal or frequency characteristics.

In some implementations, the processor 280 can identify a passenger in the vehicle by comparing device information in the passenger profiles with a device connected to the vehicle. Specifically, the processor 280 can identify the passenger by comparing the ID (Identification) of the device connected to the vehicle with the device identification information in the passenger profiles. The vehicle may be connected to the driver's device and passengers' devices simultaneously.

Between the passenger identification process and the response action process, the processor 280 can query whether to apply the profile of the identified passenger to the vehicle. If application of the passenger profile is approved, the processor 280 applies the passenger profile to the vehicle.

Otherwise, the processor 280 can apply the profile of the identified passenger to the vehicle immediately in response to the identification of the passenger.

In some implementations, in response to the identification of the passenger, the processor 280 controls the vehicle based on the preset information within the passenger profile. Various control presets within the preset information of the passenger profile can be applied to the vehicle.

For example, if the passenger is identified as a kid or a pet, the processor 280 may execute response actions such as closing the vehicle windows, setting the temperature of the air conditioning device near the passenger to 20 degrees, and setting the wind direction of the air conditioning device to be directed downward. Since the vehicle is controlled according to the preset information, there is no need for the driver or the passenger to control the windows or seats individually and manually. Therefore, the response action improves the convenience.

In some examples, the passenger profile may further include a preferred music playlist of the passenger, and the processor 280 may play the preferred music playlist in response to the identification of the passenger.

In some examples, the preset information of the passenger profile includes presets for each vehicle state. The preset information may include presets for the vehicle with the engine turned off, in addition to the presets for the vehicle to which the passenger profile is applied. For example, the preset information may include window control presets for a vehicle with the engine turned off. When the vehicle's engine is turned off, the vehicle's windows may be slightly opened based on the window control presets. When the passenger is identified as a child or a pet, the window can be opened even when the vehicle's engine is turned off, preventing the temperature inside the vehicle from rising due to intense sunlight.

In the response action process, the microphone 210 can receive a voice command from the driver or the passenger within the vehicle, and the processor 280 can execute a response action according to the voice command with reference to the passenger profile.

Specifically, the processor 280 can use the speech recognition system to identify the intent and the slot of the voice command and determine a response action based on the identified intent and slot.

The voice command can be converted to text, the text can be classified into one of the preset intents, and the slot related to the intent can be extracted from word components in the text. For example, the intent may be classified into at least one of vehicle control or POI search; the vehicle control-related slot may include the driver window, passenger seat, temperature, or air conditioning; and the POI search-related slots may include the area name, building name, restaurant name, or abbreviations thereof.

In particular, when determining a response action to the voice command, the processor 280 can refer to the passenger profile applied to the vehicle.

In some implementations, when the voice command is related to the vehicle control, the processor 280 can control the vehicle by referring to the vehicle control range within the passenger profile. When the vehicle is controlled by a voice command from the driver or the passenger, the vehicle can be controlled within the range specified in the vehicle control range.

For example, the window control range within the passenger profile for a pet may be set to one-half or one-third. Even if a voice command such as “Open the window” is received, the processor 280 can generate an action to open the vehicle window by one-half or one-third. When the passenger is a child or a pet, the response device 200 can be controlled with reference to the vehicle control range, thereby ensuring the safety of the passenger.

In some implementations, when the voice command is related to POI search, the processor 280 can provide at least one POI that satisfies the POI search option within the passenger profile.

The POI search option can include preferred POI search option, No Kids Zone exclusion option, or No Pet Zone exclusion option. The POI search option may include various search options.

The processor 280 can search POIs using the preferred POI search option within the passenger profile and provide POIs that satisfy the POI search option.

For example, “Hospital A” may be pre-registered as a preferred POI in response to the “hospital” keyword in the preferred POI search option of the passenger profile. When the driver utters “Guide me to a <hospital>,” even if the vehicle is at a far distance from Hospital A, the processor 280 may provide “Hospital A” as a response action by referring to the preferred POI search option in the passenger profile. The processor 280 may provide “Hospital A” first.

The No Kids Zone exclusion option in the passenger profile may be activated. For example, when the driver utters “Guide me to a <restaurant>,” the processor 280 may consider the No Kids Zone exclusion option and provide a search result excluding restaurants designated as No Kids Zone as a response action.

The No Pet Zone exclusion option in the passenger profile may be activated. For example, when the driver utters “Guide me to a <restaurant>,” the processor 280 may consider the No Pet Zone exclusion option and provide a search result excluding restaurants designated as No Pet Zone as a response action.

In this way, the response device 200 may provide a passenger-specific service by pre-storing a profile for each passenger and performing a response action according to a voice command with reference to the passenger's profile.

FIG. 4 is a block diagram illustrating an example of a speech recognition system.

Referring to FIG. 4, the speech recognition system 400 can recognize and understand the utterance of a user and provide a response corresponding to the user's utterance. In some implementations, the user may refer to a driver or a passenger.

In some implementations, the speech recognition system 400 can include a speech recognition module 410 configured to convert the user's utterance and voice command into text, a natural language understanding module 420 configured to determine the intent of the user's utterance, and a response generation module 430 configured to perform processing to provide a response corresponding to the intent of the user's utterance.

In some implementations, the speech recognition system 400 can further include a dialogue manager configured to manage the overall conversation between the speech recognition system 400 and the user.

The speech recognition module 410 can acquire the user's utterance received by the microphone in the vehicle and convert the user's utterance into an input sentence using at least one Speech to Text (STT) engine. The STT engine can convert a voice signal into text by applying a speech recognition algorithm or a deep learning model to the voice signal representing the user's utterance.

For example, the speech recognition module 410 can use a feature vector extraction technique such as Cepstrum, Linear Predictive Coefficient (LPC), Mel Frequency Cepstral Coefficient (MFCC), or Filter Bank Energy to extract feature vectors from the user utterances.

The speech recognition module 410 can obtain a recognition result by comparing the extracted feature vector with trained reference patterns. In some implementations, the speech recognition module 410 can use an acoustic model that models and compares the signal characteristics of speech or a language model that models the linguistic order relationship of words or syllables corresponding to recognized vocabulary.

The speech recognition module 410 can convert user utterances into input sentences in the form of text based on a model employing machine learning or deep learning.

Furthermore, before applying speech recognition, the speech recognition module 410 may preprocess the voice signal corresponding to the user's utterance. For example, the speech recognition module 410 may perform preprocessing to reduce noise in the voice signal.

The natural language understanding module 420 can use at least one Natural Language Understanding (NLU) engine to classify the intent of the user's utterance included in the input sentences and extract a slot indicating meaningful information related to the utterance intent.

For example, a slot may refer to a semantic object for providing a response according to the utterance intent. Slots may be predefined for each utterance intent. The role of a slot can be determined by the utterance intent. For example, in the input sentence “Guide me to Yanghwa Bridge,” the role of “Yanghwa Bridge” represents a point of interest, but in the input sentence “Play Yanghwa Bridge,” the role of “Yanghwa Bridge” may refer to a song title.

In some implementations, the NLU engine may determine the user's utterance intent and slot for the input sentence by comparing the input sentence with predetermined grammar. For example, when the predetermined grammar is “Call <someone>” and the input sentence is “Call Hong Gil-dong,” the NLU engine determines that the utterance intent is “Make a call” and the slot value is “Hong Gil-dong.”

In some implementations, the NLU engine may determine the utterance intent and slot for the user's input sentence using tokenization, deep learning models, and other related techniques.

Specifically, the NLU engine can segment the input sentence into morpheme-level tokens. A morpheme may refer to the smallest unit of meaning that may not be analyzed any further. Additionally, the NLU engine may tag each token with a part of speech.

The NLU engine can project tokens into the vector space. Each token or a combination of tokens can be converted into an embedding vector. To improve performance, sequence embedding, position embedding may be performed together.

The NLU engine can determine the utterance intent and slot for the input sentence by grouping embedding vectors or applying a first deep learning model and a second deep learning model to the embedding vectors, respectively. For example, the first deep learning model may be a recurrent neural network pre-trained to classify speech intent in response to the input of embedding vectors. The second deep learning model may be a recurrent neural network pre-trained to determine a slot in response to the input of embedding vectors.

Furthermore, the natural language understanding module 420 may extract information such as a domain, an entity name, or a speech act from an input sentence using the NLU engine.

Domains may refer to the information used to identify the topic of the user's utterance. For example, domains representing diverse topics such as vehicle control, information provision, text transmission, and navigation function may be determined based on the input sentence.

Entity names may refer to the proper nouns such as names of people, place names, organization names, time, date, and currency. Named Entity Recognition (NER) is the task of identifying an entity name in a sentence and determining the type of the identified entity name. Through entity name recognition, important keywords may be extracted from a sentence to understand the meaning of the sentence.

Speech act analysis can be the task of analyzing the intent of an utterance. The speech act analysis can be used to determine the intent of the utterance, such as whether the user is asking a question, making a request, responding, or simply expressing emotion.

Information such as a domain, an entity name, or a speech act may be used for at least one of the operations such as classification of the intent of the user's utterance, determination of a slot, or generation of a response according to the user's utterance.

The response generation module 430 can perform processing to provide a response corresponding to the intent of the user's utterance.

The response generation module 430 may provide responses in various forms. The response generation module 430 may provide a response according to the user's utterance through a visual, aural, or tactile interface.

The response generation module 430 may generate response information easily recognizable for a passenger using a generative model. The response generation module 430 may generate a complete sentence from information such as utterance intent, slot, domain, entity name, and speech act using the generative model.

For example, if the intent of the user's utterance is “vehicle-related control,” the response generation module 430 may transmit a signal processing result to perform vehicle-related control to the vehicle.

In another example, if the intent of the user's utterance is “provision of specific information,” the response generation module 430 may search for specific information using a slot and provide the searched information to the user terminal. If necessary, an information search may be performed on another external server.

In yet another example, if the intent of the user's utterance is “provision of specific content,” the response generation module 430 may request transmission of the target content from an external server that provides the content.

In still another example, if the intent of the user's utterance is “continuation of a simple conversation,” the response generation module 430 may generate response content according to the user's utterance and output the response visually or audibly.

In what follows, operation examples of the speech recognition system 400 will be described.

For example, when the input sentence is “When should I change the engine oil?” the NLU engine splits the input sentence into morphemes of “engine”, “oil”, “when”, “replace”, and “year” and converts each morpheme into a vector. Afterward, the NLU engine classifies the speech intent corresponding to the vector based on the similarity between the vectors and their location in the vector space. In the above example, the classified utterance intent is “Confirm replacement of disposable parts.” The NLU engine extracts word components “engine” and “oil” into slots according to the intent of “confirming replacement of disposable parts.” Subsequently, the response generation module 430 may provide a sentence such as “The engine oil change cycle is 15,000 km” based on the intent to confirm replacement of disposable parts and the slot values of “Engine” and “Oil.”

In another example, if the input sentence is “Let's go home,” the domain is identified as “navigation,” the utterance intent is “route setting,” and the slots for performing the control corresponding to the utterance intent are “start, destination.”

In yet another example, if the input sentence is “Turn on the air conditioner,” the domain is identified as “vehicle control,” the utterance intent is “Air conditioner power on,” and the slots for performing the control corresponding to the utterance intent are “air conditioner.” Additional slots may be “temperature, air volume.”

Meanwhile, the speech recognition system 400 may include at least one processor and a memory including at least one command and perform the functions of the speech recognition module 410, the natural language understanding module 420, and the response generation module 430 through execution of commands by the at least one processor. The speech recognition system 400 may further include a communication unit for communication with an external device.

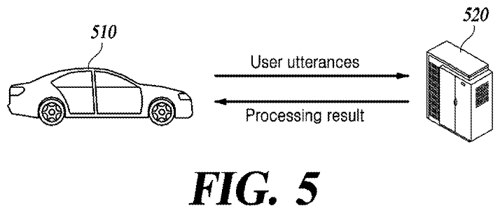

FIG. 5 illustrates a relationship between a vehicle and a speech recognition system.

Referring to FIG. 5, the response device and the speech recognition system may be implemented on at least one of the vehicle 510 or the server 520.

In some implementations, both the response device and the speech recognition system may be implemented in the vehicle 510. The controller of the response device may directly perform the functions of the speech recognition system. The response device may perform the process for registering passenger profiles, the passenger identification process, and the response action process.

In some implementations, the response device may be implemented in the vehicle 510, and the speech recognition system may be implemented in the server 520. The response device in the vehicle 510 transmits an utterance or a voice command from the driver or the passenger to the speech recognition system in the server 520. The speech recognition system processes the utterance or the voice command to generate information or control commands necessary for the passenger and transmits the information or control commands to the response device in the vehicle 510. The response device coordinates the information or control commands with reference to the passenger profile.

As an example of the passenger identification process, the response device may transmit the utterance to the speech recognition system, receive the passenger information identified by the speech recognition system, and identify the passenger based on the received passenger information.

As an example of the response action process, the response device may transmit the utterance to the speech recognition system, receive a control command determined by the speech recognition system, modify the control command with reference to the passenger profile, and control the vehicle using the modified control command.

As another example, the response device may transmit the utterance to the speech recognition system, receive the intent and slots determined by the speech recognition system, generate a control signal corresponding to the intent and slots by referring to the passenger profile, and control the vehicle using the control signal.

The functions of the response generation module in the speech recognition system are performed by the response device.

In some implementations, both the response device and the speech recognition system may be implemented in the server 520. The response device may perform the process for registering passenger profiles, the passenger identification process, and the response action process. The response device receives the initial utterance from the vehicle and identifies the passenger based on the initial utterance. Afterward, the response device receives the voice command to the vehicle and performs a response action corresponding to the voice command. Here, the response action is transmitting a control signal or information corresponding to the voice command to the vehicle.

In addition to the above, the speech recognition module, the natural language understanding module, and the response generation module in the speech recognition system may be distributed across the vehicle 510 and the server 520.

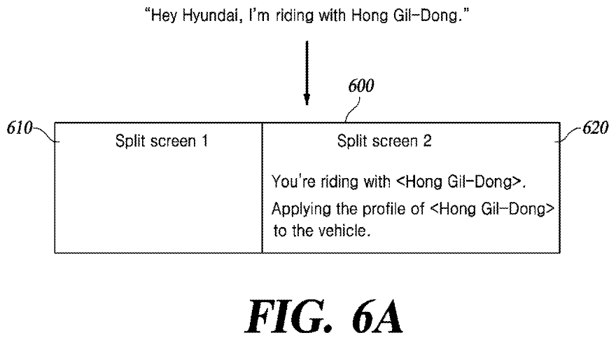

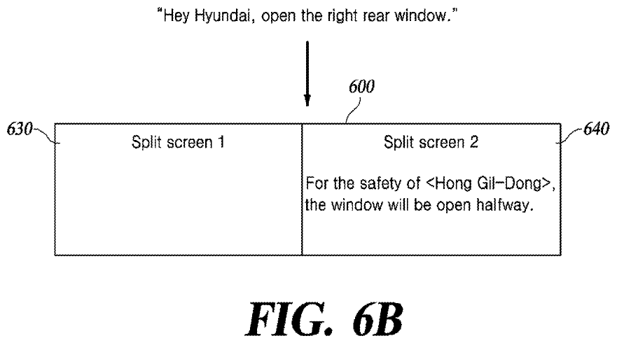

FIGS. 6A and 6B illustrate a passenger identification process and a response action process.

Referring to FIG. 6A, in the passenger identification process, an utterance from the passenger and a display device 600 installed in the response device are shown.

The screen of the display device 600 may be split into two split screens 610, 620. The first split screen 610 displays various pieces of information. The second split screen displays information related to a passenger-specific service.

The response device is installed in the vehicle.

In FIG. 6A, the speaker utters “Hey Hyundai, I'm riding with Hong Gil-Dong.”

The response device extracts the name from the utterance and identifies the passenger in the vehicle by comparing the extracted name with the names in the identification data of the pre-stored passenger profiles.

Specifically, the response device uses the STT function to convert speech in the form of audio data into input text. The response device extracts the name from the input text.

For example, to extract name from input text, the response device may use predefined grammar. The response device may store the sentence “Hey Hyundai, I'm riding with <who>” and extract the name corresponding to <who> from the input text by referring to the stored sentence.

In another example, the response device may execute the functions of the speech recognition system to extract names within the utterance. The response device classifies the utterance intent and extracts the slots by applying the functions of the speech recognition system to the input text. When the intent of the utterance is “provide the passenger information,” the response device uses the extracted slot as the name in the utterance.

In FIG. 6a, <Hong Gil-Dong> is extracted as the name.

Afterward, the response device searches for the name <Hong Gil-Dong> within passenger profiles. If a passenger profile containing the name that matches <Hong Gil-Dong> is found, the response device designates the identified passenger profile as the profile of the passenger in the vehicle.

In some implementations, the response device may perform the passenger identification process using the speech recognition system installed in the server. The response device transmits the input utterance to the speech recognition system in the server. The speech recognition system converts the input utterance into input text, extracts the name in the input text using predefined grammar or intent/slot, and transmits the extracted name to the response device. The speech recognition system may store passenger profiles, search for a passenger profile corresponding to the extracted name, and transmit the searched passenger profile to the response device. The response device obtains the profile of the passenger in the vehicle based on the name or passenger profile received from the speech recognition system.

In addition to the above, the response device may identify the passenger by comparing the results obtained by applying a deep learning model to the speech features extracted from the input utterance with the speech features registered in the passenger profiles. Alternatively, the response device may determine whose device is connected to the vehicle by referring to the passenger profiles.

The response device may display the name <Hong Gil-Dong> of the identified passenger on the second split screen 620.

Referring to FIG. 6b, in the response action process, the passenger's utterance and the display device 600 installed in the response device are shown.

<Hong Gil-dong>, the passenger in the vehicle, is identified, and the profile of <Hong Gil-dong> is applied to the vehicle. In the profile of <Hong Gil-dong>, the window control range may be set to one-half.

The speaker utters, “Hey Hyundai, open the right rear window.”

The response device can control the window as a response action corresponding to the input utterance. When controlling windows, the response device refers to the vehicle control range in the profile of <Hong Gil-dong>.

Specifically, the response device converts the input utterance into input text.

The response device extracts the speech intent and slots from the input text using the functions of the speech recognition system. The intent of the utterance is “open the window,” and the slots are “right,” “rear seat,” and “window.”

The response device generates a control signal to open the right rear window of the vehicle based on the utterance intent and slots. At this time, the response device refers to the profile of <Hong Gil-dong> and generates a control signal that controls the right rear window to open halfway.

The response device transmits a control signal to the window control device to control the right rear window of the vehicle.

The response device may display content related to the window control applied to the vehicle on the second split screen 640.

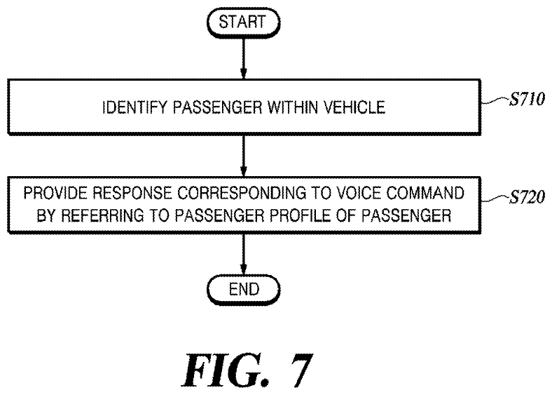

FIG. 7 is a flow diagram illustrating a method for operating a response device.

In the process for registering passenger profiles, the response device stores the profile for each passenger in advance.

The passenger profile includes at least one of identification data, vehicle control range, POI search options, or preset information.

The identification data includes at least one of the passenger's name, voice characteristics, or device information.

The vehicle control range includes at least one of a window control range, a seat control range, a temperature control range, an air conditioning control range, a lighting control range, a volume control range, and a media control range.

The POI search option includes at least one of a preferred POI search option, a No Kids Zone exclusion option, or a No Pet Zone exclusion option.

The preset information includes at least one of window control presets, seat control presets, temperature control presets, air conditioning control presets, lighting control presets, volume control presets, or media presets.

Referring to FIG. 7, the response device identifies a passenger in the vehicle S710.

The response device uses at least one of the passenger's name, voice characteristics, or device information in the passenger profiles to identify the passenger from at least one of utterances from the driver or the passenger, the connection state of the passenger's device, or any combinations thereof.

Meanwhile, the response device may control the vehicle based on the preset information in the passenger profile in response to identifying the passenger.

The response device performs a response action corresponding to a voice command uttered by the driver or the passenger in the vehicle by referring to the passenger profile of the identified passenger S720.

When the voice command is related to vehicle control, the response device controls the vehicle by referring to the vehicle control range in the passenger profile.

When the voice command relates to a POI search, the response device provides at least one POI searched using the POI search option in the passenger profile.

In some implementations, passenger-specific services may be provided by performing response actions based on voice commands with reference to pre-stored passenger profiles.

The technical effects of the present disclosure are not limited to the technical effects described above, and other technical effects not mentioned herein may be understood to those skilled in the art to which the present disclosure belongs from the description below.

Various techniques described herein may be implemented in digital electronic circuitry, or in computer hardware, firmware, software, or combinations thereof. Implementations may be in the form of a computer program tangibly embodied in a computer program product, i.e., an information carrier, e.g., a machine-readable storage device (computer-readable medium) or a propagated signal, for processing by, or controlling, the operation of, a data processing device, e.g., a programmable processor, a computer, or a number of computers. A computer program, such as the above-mentioned computer program(s), may be written in any form of programming language, including compiled or interpreted languages and may be deployed in any form, including as a stand-alone program or as a module, component, subroutine, or other unit suitable for use in a computing environment. The computer program may be deployed to run on a single computer or multiple computers at one site or distributed across multiple sites and interconnected by a communications network.

In addition, components of the present disclosure may use an integrated circuit structure such as a memory, a processor, a logic circuit, a look-up table, and the like. These integrated circuit structures execute each of the functions described herein through the control of one or more microprocessors or other control devices. In addition, components of the present disclosure may be specifically implemented by a program or a portion of a code that includes one or more executable instructions for performing a specific logical function and is executed by one or more microprocessors or other control devices. In addition, components of the present disclosure may include or be implemented as a Central Processing Unit (CPU), a microprocessor, etc. that perform respective functions. In addition, components of the present disclosure may store instructions executed by one or more processors in one or more memories.

Processors suitable for processing computer programs include, by way of example, both general purpose and special purpose microprocessors, as well as one or more processors of any kind of digital computer. Generally, a processor will receive instructions and data from a read-only memory or a random access memory or both. The essential elements of a computer may include at least one processor that executes instructions and one or more memory devices that store instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include, by way of example, semiconductor memory devices, e.g., Magnetic Media such as hard disks, floppy disks, and magnetic tapes, Optical Media such as Compact Disk Read Only Memories (CD-ROMs) and Digital Video Disks (DVDs), Magneto-Optical Medial such as Floptical Disks, Rea Only Memories (ROMs), Random Access Memories (RAMs), flash memories, Erasable Programmable ROMs (EPROMs), Electrically Erasable Programmable ROMs (EEPROM), etc. The processor and the memory may be supplemented by, or incorporated in, special purpose logic circuitry.

The processor may execute an Operating System and software applications executed on the Operating System. Moreover, a processor device may access, store, manipulate, process, and generate data in response to software execution. For the sake of convenience, there is a case where a single processor device is used, but those skilled in the art will understand that the processor device can include multiple processing elements and/or multiple types of processing elements. For example, the processor device may include a plurality of processors or a single processor and a single controller. Other processing configurations, such as such as parallel processors, are also possible.

In addition, non-transitory computer-readable media may be any available media that can be accessed by a computer, and may include both computer storage media and transmission media.

This specification includes details of various specific implementations, but they should not be understood as limiting the scope of any invention or what is claimed, and should be understood as descriptions of features that may be unique to particular embodiments of a particular invention. In the context of individual embodiments, specific features described herein may also be implemented in combination with a single embodiment. On the contrary, various features described in the context of a single embodiment can also be implemented in multiple embodiments independently or in any appropriate sub-combination. Further, although the features may operate in a particular combination and may be initially described as so claimed, one or more features from the claimed combination may be in some cases excluded from the combination, and the claimed combination may be modified into a sub-combination or a variation of the sub-combination.

Likewise, although the operations are depicted in the drawings in a particular order, it should not be understood that such operations must be performed in that particular order or sequential order shown to achieve the desirable result or that all the depicted operations should be performed. In certain cases, multitasking and parallel processing may be advantageous. Moreover, the separation of various device components of the above-described embodiments should not be understood as requiring such separation in all embodiments, and it should be understood that the described program components and devices can generally be integrated together in a single software product or packaged into multiple software products.

The foregoing description is merely illustrative of the technical concept of the present embodiments. Various modifications and changes may be made by those of ordinary skill in the art without departing from the essential characteristics of each embodiment. Therefore, the present embodiments are not intended to limit but to describe the technical idea of the present embodiments. The scope of the technical concept of the embodiments is not limited by these embodiments. The scope of protection of the various embodiments should be construed by the following claims. All technical ideas that fall within the scope of equivalents thereof should be interpreted as being included in the scope of the present embodiments.

What is claimed is:

1. A method for performing a response action to a voice command based on a passenger profile, the method comprising:
identifying a passenger in a vehicle; and
performing a response action corresponding to a voice command uttered by the identified passenger or a driver based on a passenger profile of the passenger,
wherein the passenger profile includes at least one of a vehicle control range, a points of interest (POI) search option, or preset information.

2. The method of claim 1, wherein performing the response action comprises, based on the voice command being related to vehicle control, controlling the vehicle according to the vehicle control range within the passenger profile.

3. The method of claim 2, wherein the vehicle control range includes at least one of a window control range, a seat control range, a temperature control range, an air conditioning control range, a lighting control range, a volume control range, or a media control range.

4. The method of claim 1, wherein performing the response action includes, based on the voice command being related to a POI search, providing at least one POI searched using the POI search option within the passenger profile.

5. The method of claim 4, wherein the POI search option includes at least one of a preferred POI search option, a No Kids Zone exclusion option, or a No Pet Zone exclusion option.

6. The method of claim 1, further comprising:
controlling the vehicle based on the preset information within the passenger profile in response the identification of the passenger.

7. The method of claim 6, wherein the preset information includes at least one of window control presets, seat control presets, temperature control presets, air conditioning control presets, lighting control presets, volume control presets, or media presets.

8. The method of claim 1, wherein the passenger profile includes at least one of name, voice characteristics, or device information of the passenger, and
wherein identifying of the passenger includes:
identifying the passenger using at least one of a connection state of a device of the passenger or utterances from the passenger or the driver based on at least one of the name, the voice characteristics, or the device information of the passenger within the passenger profile.

9. A device configured to execute a response action to a voice command based on a passenger profile, the device comprising:
a memory storing instructions and a passenger profile, the passenger profile including at least one of a vehicle control range, a points of interest (POI) search option, or preset information; and
a processor configured to execute the instructions to perform operations comprising:
identifying a passenger in a vehicle, and
performing a response action corresponding to a voice command uttered by the identified passenger or a driver based on a passenger profile of the passenger.

10. The device of claim 9, wherein the processor is configured to, based on the voice command being related to vehicle control, control the vehicle according to the vehicle control range within the passenger profile.

11. The device of claim 10, wherein the vehicle control range includes at least one of a window control range, a seat control range, a temperature control range, an air conditioning control range, a lighting control range, a volume control range, or a media control range.

12. The device of claim 9, wherein the processor is configured to, based on the voice command being related to a POI search, the processor provides at least one POI searched using the POI search option within the passenger profile.

13. The device of claim 12, wherein the POI search option includes at least one of a preferred POI search option, a No Kids Zone exclusion option, or a No Pet Zone exclusion option.

14. The device of claim 9, wherein the processor is configured to control the vehicle based on the preset information within the passenger profile in response to the identification of the passenger.

15. The device of claim 14, wherein the preset information includes at least one of window control presets, seat control presets, temperature control presets, air conditioning control presets, lighting control presets, volume control presets, or media presets.

16. The device of claim 9, wherein the passenger profile includes at least one of name, voice characteristics, or device information of the passenger, and
wherein the processor is configured to identify the passenger using at least one of a connection state of a device of the passenger or utterances from the passenger or the driver based on at least one of the name, the voice characteristics, or the device information of the passenger within the passenger profile.
